(19) United States
(12) Patent Application Publication
(10) Pub. No.: US 2024/0198523 A1
(43) Pub. Date: Jun. 20, 2024

(54) ROBOT SYSTEM, AND CONTROL METHOD AND CONTROL PROGRAM THEREOF

(71) Applicant: KAWASAKI JUKOGYO KABUSHIKI KAISHA, Kobe-shi, Hyogo (JP)

(72) Inventors: Kentaro AZUMA, Kobe-shi (JP); Tomoki SAKUMA, Kobe-shi (JP); Masayuki KAMON, Kobe-shi (JP); Hirokazu SUGIYAMA, Kobe-shi (JP); Masahiko AKAMATSU, Kobe-shi (JP); Takanori KOZUKI, Kobe-shi (JP); Takanori KIRITOSHI, Kobe-shi (JP); Jun FUJIMORI, Kobe-shi (JP); Hiroki KINOSHITA, Kobe-shi (JP); Hiroki TAKAHASHI, Kobe-shi (JP); Kai SHIMIZU, Kobe-shi (JP); Yoshiki NAITO, Kobe-shi (JP)

(73) Assignee: KAWASAKI JUKOGYO KABUSHIKI KAISHA, Kobe-shi, Hyogo (JP)

(21) Appl. No.: 18/555,280

(22) PCT Filed: Apr. 11, 2022
(86) PCT No.: PCT/JP2022/017490

§ 371 Date: Oct. 13, 2023

(30) Foreign Application Priority Data
Apr. 15, 2021 (JP) 2021-069305

(51) Int. Cl. B25J 9/16; B25J 3/04; B25J 11/00; B25J 13/02; B25J 13/08

(52) U.S. Cl. CPC B25J 9/1664; B25J 3/04; B25J 11/0055; B25J 11/0065; B25J 13/02; B25J 13/085

(57) ABSTRACT

A robot system 100 includes an operator 2 to be operated by a user, a robot 1 having an end effector 11 that acts on an object W and a robot arm 12 that moves the end effector 11, and a controller 3 that outputs a command for the robot arm 12 such that the end effector 11 moves according to operation information input via the operator 2. The controller 3 performs coordinate conversion to adapt a reference surface RP in an operation coordinate system set for the operator 2 to the surface of the object W, and generates the command for the robot arm 12 based on the operation information.

### FIELD

The technique disclosed herein relates to a robot system and control method and program therefor.

### BACKGROUND

Conventionally, a robot system that acts on an object by moving a robot has been known.

For example, Patent Document 1 discloses a robot system that processes an object by a robot arm having a tool such as a grinder. In this robot system, a control device controls the robot arm to implement desired processing by the tool.

### CITATION LIST

### Patent Document

Patent Document 1: Japanese Unexamined Patent Application Publication No. 2017-1122

### SUMMARY OF THE INVENTION

Not automatic control for the robot arm by the control device, but manual control via user's operation is conceivable. That is, it is considered that a user operates a master to move a slave such as a robot. In such a robot system, the user can operate, i.e., remotely operate, the master from a position distant from a site where the slave is arranged, for example.

However, unlike a work performed by the user with the user actually gripping, e.g., a tool, it is difficult to obtain feedback via the senses of sight, touch, hearing, etc. in the remote operation, and there is an operation difficulty different from that of the actual work.

The technique disclosed herein has been made in view of the above-described points, and an object thereof is to improve operability when the slave is moved by operation of the master.

A robot system of the present disclosure includes a master to be operated by a user, a slave having an effector that acts on an object and a mover that moves the effector, and a controller that outputs a command for the mover such that the effector moves according to operation information input via the master. The controller performs coordinate conversion to adapt a reference surface in an operation coordinate system set for the master to the surface of the object, and generates the command for the mover based on the operation information.

A method for controlling a robot system according to the present disclosure is a method for controlling a robot system including a master to be operated by a user and a slave having an effector that acts on an object and a mover that moves the effector, the method including outputting a command for the mover such that the effector moves according to operation information input via the master and performing coordinate conversion to adapt a reference surface in an operation coordinate system set for the master to the surface of the object when generating the command for the mover based on the operation information.

A control program of the present disclosure is a control program causing a computer to implement a function of controlling a robot system including a master to be operated by a user and a slave having an effector that acts on an object and a mover that moves the effector, the function including a function of outputting a command for the mover such that the effector moves according to operation information input via the master and a function of performing coordinate conversion to adapt a reference surface in an operation coordinate system set for the master to the surface of the object when generating the command for the mover based on the operation information.

According to the above-described robot system, the operability when the slave is moved by operation of the master can be improved.

According to the above-described method for controlling the robot system, the operability when the slave is moved by operation of the master can be improved.

According to the above-described control program, operability when the slave is moved by operation of the master can be improved.

### BRIEF DESCRIPTION OF THE DRAWINGS

FIG. 1 is a schematic view showing the configuration of a robot system.

FIG. 2 is an enlarged view of an end effector.

FIG. 3 is a diagram showing a schematic hardware configuration of a robot controller.

FIG. 4 is a perspective view of an operator.

FIG. 5 is a diagram showing a schematic hardware configuration of an operation controller.

FIG. 6 is a diagram showing a schematic hardware configuration of a controller.

FIG. 7 is a block diagram showing the configuration of a control system for the robot system.

FIG. 8 is a schematic view showing the normal of an object to an intersection between a reference axis and the object.

FIG. 9 is a flowchart showing movement of the robot system.

FIG. 10 is a schematic view of a handle to be operated by a user.

FIG. 11 is a schematic view showing movement of the end effector in a case where coordinate conversion is not performed.

FIG. 12 is a schematic view showing movement of the end effector in a case where the coordinate conversion is performed.

FIG. 13 is a schematic view of a handle to be operated by a user in a modification.

### DESCRIPTION OF EMBODIMENTS

Hereinafter, an exemplary embodiment will be described in detail with reference to the drawings.

In the present disclosure, a work performed by a robot does not include a teaching work and a teaching checking/correction work. Thus, an operator 2 in description below does not include a teach pendant.

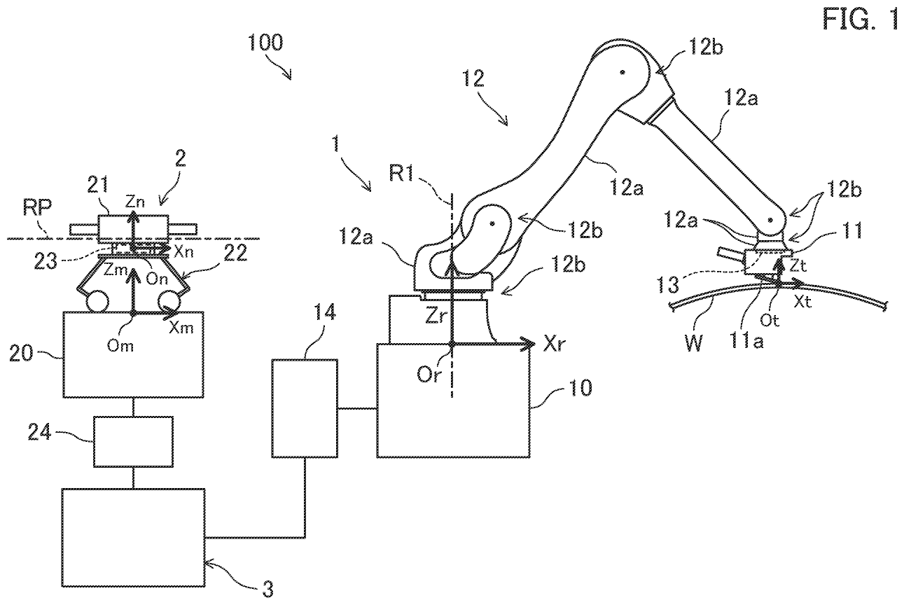

FIG. 1 is a schematic view showing the configuration of a robot system 100 according to the embodiment.

The robot system 100 includes a robot 1, the operator 2 to be operated by a user, and a controller 3 that controls the robot 1. The robot system 100 includes a master-slave system. The operator 2 functions as a master, and the robot 1 functions as a slave. The controller 3 controls the entirety of the robot system 100, and performs bilateral control between the robot 1 and the operator 2.

The robot 1 is, for example, an industrial robot. The robot 1 has an end effector 11 that acts on an object W and a robot arm 12 that moves the end effector 11. The end effector 11 is coupled to the tip end of the robot arm 12. The robot 1 moves the end effector 11, i.e., causes motion of the end effector 11, by the robot arm 12, and accordingly, the end effector 11 acts on the object W. For example, the action of the end effector 11 is processing. For example, the object W is a curved wall of a large tank.

The robot 1 may further have a base 10 that supports the robot arm 12 and a robot controller 14 that controls the entirety of the robot 1.

The robot arm 12 changes the position and posture of the end effector 11. The robot arm 12 is a vertical articulated robot arm. The robot arm 12 has links 12a, joints 12b connecting the links 12a to each other, and a servo motor 15 (see FIG. 3) that rotationally drives the joints 12b. For example, the link 12a positioned at one end portion (end portion opposite to the end effector 11) of the robot arm 12 is coupled to the base 10 via the joint 12b so as to rotate about a rotation axis R1 extending in the vertical direction. The robot arm 12 is one example of a mover.

Note that the robot arm 12 may be, for example, of a horizontal articulated type, a parallel link type, a Cartesian coordinate type, or a polar coordinate type.

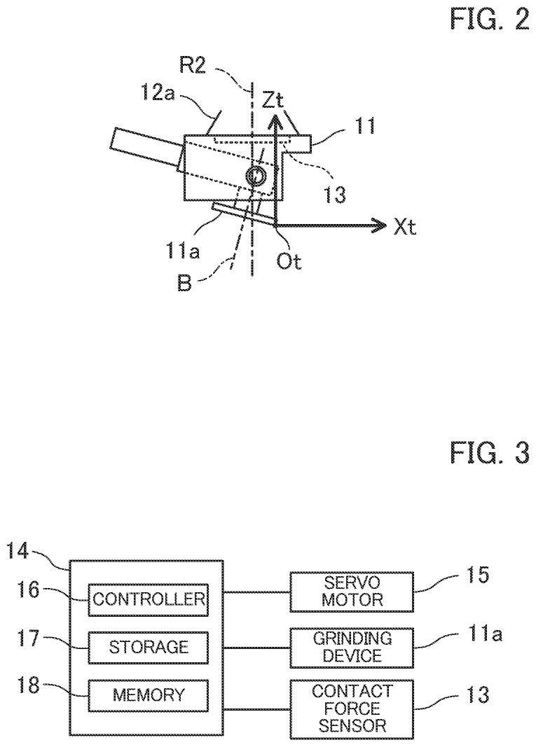

FIG. 2 is an enlarged view of the end effector 11. The end effector 11 has a grinding device 11a, and as the action, grinds the object W. The end effector 11 is one example of an effector. Note that the action of the end effector 11 on the object W is not necessarily grinding, and for example, may be cutting or polishing.

For example, the grinding device 11a may be a grinder, an orbital sander, a random orbital sander, a delta sander, or a belt sander. The grinder may be, for example, of such a type that a discoid grinding stone rotates or a conical or circular columnar grinding stone rotates. Here, the grinding device 11a is the grinder of such a type that the discoid grinding stone rotates.

For the robot 1, an orthogonal three-axis slave coordinate system is defined. The slave coordinate system is set with reference to the robot 1. The slave coordinate system has an Xr-axis, a Yr-axis, and a Zr-axis orthogonal to each other. The Xr-axis, the Yr-axis, and the Zr-axis intersect with each other at an origin Or. The origin Or is positioned on the upper surface of the base 10. The Xr-axis and the Yr-axis extend in the horizontal direction, i.e., in parallel with the upper surface of the base 10. The Zr-axis extends in the vertical direction. The Zr-axis is coincident with the rotation axis R1 of the joint 12b coupling the robot arm 12 and the base 10 to each other. The Yr-axis extends perpendicularly to the plane of paper of FIG. 1.

For the end effector 11, an orthogonal three-axis tool coordinate system is defined. The tool coordinate system is a coordinate system fixed to the end effector 11. As shown in FIG. 2, the tool coordinate system has an Xt-axis, a Yt-axis, and a Zt-axis orthogonal to each other. The Xt-axis, the Yt-axis, and the Zt-axis intersect with each other at an origin Ot. For example, the origin Ot is positioned at the contact point of the grinding device 11a with the object W. Specifically, the rotation axis B of the grinding stone of the grinding device 11a is inclined with respect to the rotation axis R2 of the link 12a to which the end effector 11 is attached. A portion of the outer peripheral edge of the grinding stone farthest from the link 12a in the direction of the rotation axis R2 is assumed as the contact point with the object W. The Zt-axis extends in parallel with the rotation axis R2. The Xt-axis is set such that the rotation axis B of the grinding stone extends in an Xt-Zt plane. The Yt-axis extends perpendicularly to the plane of paper of FIG. 1. The tool coordinate system changes according to the position/posture of the end effector 11 as viewed from the slave coordinate system. That is, the tool coordinate system moves together with the end effector 11 in association with movement of the robot arm 12.

The robot 1 may further have a contact force sensor 13 that detects reactive force (hereinafter referred to as “contact force”) received from the object by the end effector 11.

In this example, the contact force sensor 13 is disposed between the robot arm 12 and the end effector 11 (specifically at a coupled portion between the robot arm 12 and the end effector 11). The contact force sensor 13 detects force in the three axis directions orthogonal to each other and moment about these three axes. The contact force sensor 13 is one example of a contact force detector.

Note that the contact force detector is not limited to the contact force sensor 13. For example, the contact force sensor 13 may detect force only in uniaxial, biaxial, or triaxial directions. Alternatively, the contact force detector may be, for example, a current sensor that detects the current of the servo motor 15 of the robot arm 12 or a torque sensor that detects the torque of the servo motor 15.

FIG. 3 is a diagram showing a schematic hardware configuration of the robot controller 14. The robot controller 14 controls the servo motor 15 of the robot arm 12 and the grinding device 11a. The robot controller 14 receives a detection signal of the contact force sensor 13. The robot controller 14 transmits information, commands, data, etc. to the controller 3, and receives information, commands, data, etc. from the controller 3. The robot controller 14 has a controller 16, a storage 17, and a memory 18.

The controller 16 controls the entirety of the robot controller 14. The controller 16 performs various types of arithmetic processing. For example, the controller 16 includes a processor such as a central processing unit (CPU). The controller 16 may include, for example, a micro controller unit (MCU), a micro processor unit (MPU), a field programmable gate array (FPGA), and a programmable logic controller (PLC).

The storage 17 stores programs to be executed by the controller 16 and various types of data. The storage 17 includes, for example, a non-volatile memory, a hard disc drive (HDD), and a solid state drive (SSD).

The memory 18 temporarily stores data etc. For example, the memory 18 includes a volatile memory.

As shown in FIG. 1, the operator 2 has a handle 21 to be operated by the user and an operation force sensor 23 that detects operation force applied from the user to the handle 21. The operator 2 receives input for operating the robot 1 by manual operation, and outputs operation information which is the input information to the controller 3. Specifically, the user operates the operator 2 with gripping the handle 21. Force applied to the handle 21 at this time is detected by the operation force sensor 23. The operation force detected by the operation force sensor 23 is output as the operation information to the controller 3.

The operator 2 may further have a base 20, a support 22 that supports the handle 21, and an operation controller 24 that controls the entirety of the operator 2. In response to control from the controller 3, the operator 2 applies reactive force of the operation force to the user. Specifically, the operation controller 24 controls the support 22 in response to a command from the controller 3, thereby causing the user to sense the reactive force. The support 22 is one example of a support.

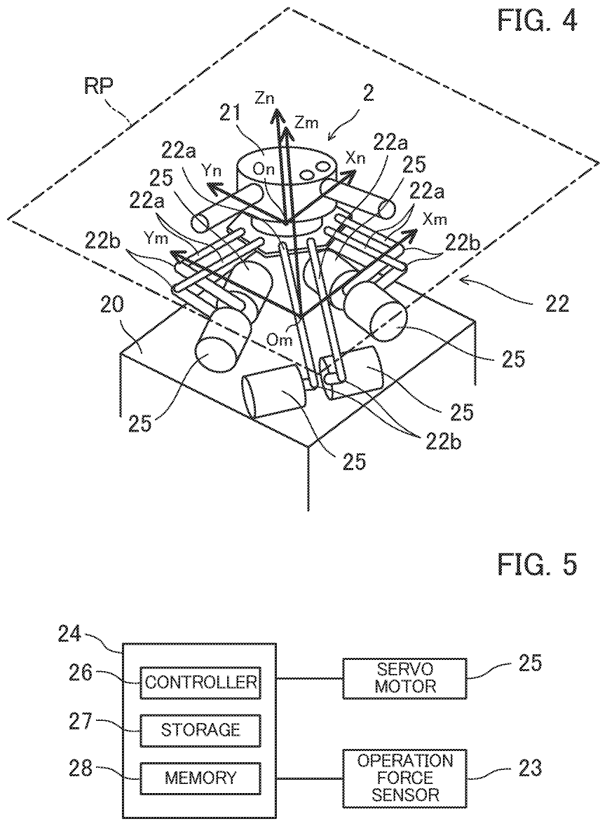

FIG. 4 is a perspective view of the operator 2. The support 22 has six arms 22a. A pair of arms 22a includes two arms 22a. That is, the support 22 has three pairs of arms 22a. The three pairs of arms 22a radially extend from the handle 21. Each arm 22a has a joint 22b. Each joint 22b couples two links of the arm 22a via a universal coupling such as a ball joint such that these two links are rotatable about the three axes orthogonal to each other. Each arm 22a is bendable at the joint 22b. One end of each arm 22a is coupled to the handle 21 via a universal coupling such as a ball joint such that the arm 22a rotates about the three axes orthogonal to each other. The other end of each arm 22a is coupled to a servo motor 25 via, e.g., a reducer (not shown). The servo motor 25 is arranged on the base 20.

Six servo motors 25 are arranged on the upper surface of the base 20. A pair of servo motors 25 includes two servo motors 25 coupled to the two arms 22a of the same pair. The rotation axes of the two servo motors 25 of each pair extend in line, i.e., on the same axis. The six servo motors 25 are arranged such that the rotation axes of the three pairs of servo motors 25 are in a triangular shape.

The support 22 configured in this manner supports the handle 21 such that the handle 21 is in an arbitrary posture at an arbitrary position in a three-dimensional space. The servo motors 25 rotate corresponding to the position and posture of the handle 21. The rotation amount, i.e., the rotation angle, of the servo motor 25 is uniquely determined.

For the operator 2, an orthogonal three-axis master coordinate system is defined. The master coordinate system is set with reference to the operator 2. The master coordinate system has an Xm-axis, a Ym-axis, and a Zm-axis orthogonal to each other. The Xm-axis, the Ym-axis, and the Zm-axis intersect with each other at an origin Om. The origin Om is positioned on the upper surface of the base 20. The Xm-axis and the Ym-axis extend in the horizontal direction, i.e., in parallel with the upper surface of the base 20. The Zm-axis extends in the vertical direction. The Zm-axis passes through the center of gravity of the triangle of the rotation axes of the three pairs of servo motors 25. The master coordinate system is a coordinate system fixed to the base 20 of the operator 2.

For the handle 21, an orthogonal three-axis operation coordinate system is defined. The operation coordinate system is a coordinate system fixed to the handle 21. The operation coordinate system has an Xn-axis, a Yn-axis, and a Zn-axis orthogonal to each other. The Xn-axis, the Yn-axis, and the Zn-axis intersect with each other at an origin On. For example, the origin On is positioned at the center of the handle 21. The operation coordinate system changes according to the position/posture of the handle 21 as viewed from the master coordinate system. That is, the operation coordinate system moves together with the handle 21 in association with movement of the handle 21. In this example, the operation coordinate system corresponds to the tool coordinate system.

Further, in the operation coordinate system, a reference surface RP is set. In this example, the reference surface RP is a plane, specifically a plane parallel with an Xn-Yn plane.

In this example, the operation force sensor 23 is disposed between the handle 21 and the support 22 (specifically at a coupled portion between the handle 21 and the support 22), as shown in FIG. 1. The operation force sensor 23 detects force in the three axis directions orthogonal to each other and moment about these three axes. The operation force sensor 23 is one example of an operation force detector.

Note that the operation force detector is not limited to the operation force sensor 23. For example, the operation force sensor 23 may detect force only in uniaxial, biaxial, or triaxial directions. Alternatively, the operation force detector may be, for example, a current sensor that detects the current of the servo motor 25 of the support 22 or a torque sensor that detects the torque of the servo motor 25.

FIG. 5 is a diagram showing a schematic hardware configuration of the operation controller 24. The operation controller 24 controls the servo motors 25 to move the support 22. The operation controller 24 receives a detection signal of the operation force sensor 23. The operation controller 24 transmits information, commands, data, etc. to the controller 3, and receives information, commands, data, etc. from the controller 3. The operation controller 24 has a controller 26, a storage 27, and a memory 28.

The controller 26 controls the entirety of the operation controller 24. The controller 26 performs various types of arithmetic processing. For example, the controller 26 includes a processor such as a central processing unit (CPU). The controller 26 may include, for example, a micro controller unit (MCU), a micro processor unit (MPU), a field programmable gate array (FPGA), and a programmable logic controller (PLC).

The storage 27 stores programs to be executed by the controller 26 and various types of data. The storage 27 includes, for example, a non-volatile memory, a hard disc drive (HDD), and a solid state drive (SSD).

The memory 28 temporarily stores data etc. For example, the memory 28 includes a volatile memory.

The controller 3 controls the robot 1 and the operator 2. The controller 3 outputs a slave command which is a command for the robot arm 12 to the robot 1 such that the end effector 11 moves according to the operation information input via the operator 2. The controller 3 controls the robot arm 12 according to the operation via the operator 2, and accordingly, the end effector 11 acts on the object W. Further, the controller 3 outputs a master command which is a command for the support 22 to the operator 2 such that the handle 21 moves according to the reactive force received from the object W by the robot 1. The controller 3 controls the support 22, and accordingly, applies the reactive force received by the end effector 11 from the object W to the user.

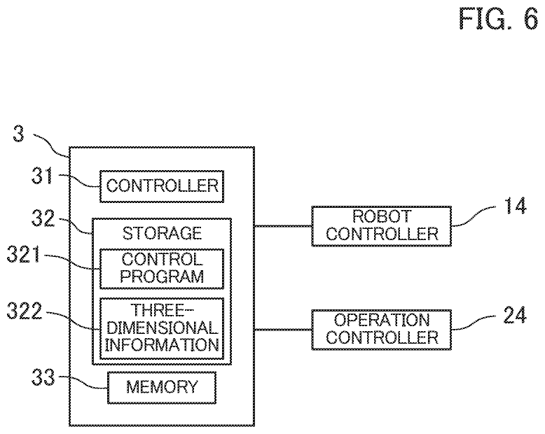

FIG. 6 is a diagram showing a schematic hardware configuration of the controller 3. The controller 3 transmits information, commands, data, etc. to the robot controller 14 and the operation controller 24, and receives information, commands, data, etc. from the robot controller 14 and the operation controller 24. The controller 3 has a controller 31, a storage 32, and a memory 33.

The controller 31 controls the entirety of the controller 3. The controller 31 performs various types of arithmetic processing. For example, the controller 31 includes a processor such as a central processing unit (CPU). The controller 31 may include, for example, a micro controller unit (MCU), a micro processor unit (MPU), a field programmable gate array (FPGA), and a programmable logic controller (PLC).

The storage 32 stores programs to be executed by the controller 31 and various types of data. The storage 32 includes, for example, a non-volatile memory, a hard disc drive (HDD), and a solid state drive (SSD). For example, the storage 32 stores a control program 321 and three-dimensional information 322 on the object W.

The control program 321 is a program for causing the controller 31 which is the computer to implement a function of controlling the robot system 100.

The three-dimensional information 322 on the object W is information indicating the surface of the object W. For example, the three-dimensional information 322 on the object W is standard triangulated language (STL) data on the object W. That is, the surface of the object W is expressed by polygons, and coordinate information on each polygon is stored as the three-dimensional information 322 in the storage 32. The coordinate information on each polygon is coordinate information in a workpiece coordinate system set for the object W. The storage 32 also stores a positional relationship between the origin of the workpiece coordinate system and the origin of the slave coordinate system.

The three-dimensional information 322 on the object W is acquired in advance, and is stored in the storage 32. For example, the surface of the object W is measured by, e.g., a three-dimensional scanner, and in this manner, point cloud data on the object W is acquired. The object W is polygonized from the point cloud data, and in this manner, the STL data is acquired. Alternatively, the STL data may be acquired from design data on the object W, such as CAD data.

The memory 33 temporarily stores data etc. For example, the memory 33 includes a volatile memory.

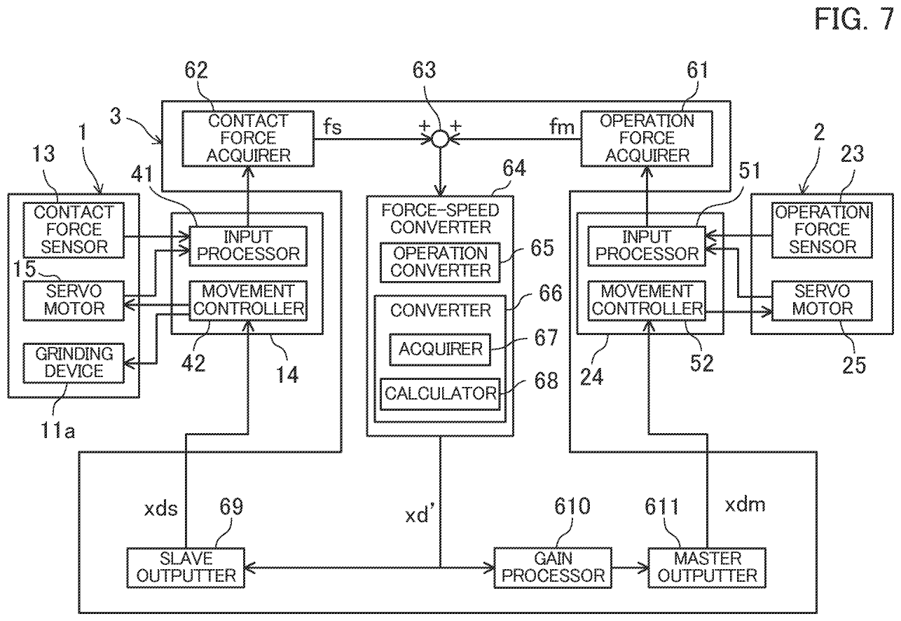

FIG. 7 is a block diagram showing the configuration of a control system for the robot system 100.

The controller 16 of the robot controller 14 reads and loads the programs from the storage 17 into the memory 18, thereby implementing various functions.

Specifically, the controller 16 functions as an input processor 41 and a movement controller 42.

The input processor 41 outputs, to the controller 3, information, data, commands, etc. received from the contact force sensor 13 and the servo motor 15. Specifically, the input processor 41 receives a six-axis force detection signal from the contact force sensor 13, and outputs the detection signal as the operation information to the controller 3. Moreover, the input processor 41 receives, from the servo motor 15, detection signals of a rotation sensor (e.g., encoder) and a current sensor. The input processor 41 outputs, to the movement controller 42, these detection signals for feedback control for the robot arm 12 by the movement controller 42. Further, the input processor 41 outputs, to the controller 3, these detection signals as position information on the robot arm 12.

The movement controller 42 receives a slave command (specifically, command position xds) from the controller 3, and according to the slave command, generates a control command for moving the robot arm 12. The movement controller 42 outputs the control command to the servo motor 15 to move the robot arm 12 and move the grinding device 11a to a position corresponding to the command position. At this time, the movement controller 42 performs feedback control of movement of the robot arm 12 based on the detection signals of the rotation sensor and/or the current sensor of the servo motor 15 from the input processor 41. Moreover, the movement controller 42 outputs the control command to the grinding device 11a to move the grinding device 11a. Accordingly, the grinding device 11a grinds the object W.

The controller 26 of the operation controller 24 reads and loads the programs from the storage 27 into the memory 28, thereby implementing various functions. Specifically, the controller 26 functions as an input processor 51 and a movement controller 52.

The input processor 51 outputs, to the controller 3, information, data, commands, etc. received from the operation force sensor 23. Specifically, the input processor 51 receives a six-axis force detection signal from the operation force sensor 23, and outputs the detection signal as reactive force information to the controller 3. Moreover, the input processor 51 receives, from the servo motors 25, detection signals of rotation sensors (e.g., encoders) and current sensors. The input processor 51 outputs, to the movement controller 52, these detection signals for feedback control for the support 22 by the movement controller 52.

The movement controller 52 receives a master command (specifically, command position xdm) from the controller 3, and according to the master command, generates a control command for moving the support 22. The movement controller 52 outputs the control command to the servo motors 25 to move the support 22 and move the handle 21 to a position corresponding to the command position. At this time, the movement controller 52 performs feedback control of movement of the support 22 based on the detection signals of the rotation sensors and/or the current sensors of the servo motors 25 from the input processor 51. Accordingly, the reactive force of the operation force on the handle 21 from the user is applied. As a result, the user can operate the handle 21 while artificially sensing the reactive force from the object W via the handle 21.

The controller 31 of the controller 3 reads and loads the control program 321 from the storage 32 into the memory 33, thereby implementing various functions. Specifically, the controller 31 functions as an operation force acquirer 61, a contact force acquirer 62, an adder 63, a force-speed converter 64, a slave outputter 69, a gain processor 610, and a master outputter 611.

With these functions, the controller 3 generates the slave command and the master command according to the operation information and the reactive force information. When generating the slave command from the operation information, the controller 3 performs coordinate conversion to adapt the reference surface RP in the operation coordinate system set for the operator 2 to the surface of the object W. That is, when generating the slave command for moving the end effector 11 from the operation information on the operator 2, the controller 3 executes the coordinate conversion with the same adaptation relationship as adaptation of the reference surface RP to the surface of the object W. For example, in a case where the user operates the operator 2 along the reference surface RP, the controller 3 generates a slave command for moving the end effector 11 along the surface of the object W. The reference surface RP is a virtual plane in the operation coordinate system, and in this example, is a plane (e.g., plane parallel with the Xn-Yn plane of the operation coordinate system) in the operation coordinate system. The coordinate conversion means translation from a coordinate system for operation information to a coordinate system for a generated slave command. That is, the coordinate conversion is performed regardless of at which stage the coordinate conversion is performed, such as whether the operation information is first subjected to the coordination conversion or at a final stage of generating the slave command.

Further, the controller 3 maintains the posture of the end effector 11 with respect to the surface of the object W constant in the coordinate conversion. Specifically, the controller 3 changes the posture of the end effector 11 such that a reference axis A defined in the tool coordinate system set for the end effector 11 is coincident with the normal of the object W to an intersection between the reference axis A and the surface of the object W, thereby maintaining the posture of the end effector 11 with respect to the surface of the object W constant. In this example, the reference axis A is the Zt-axis of the tool coordinate system.

The operation force acquirer 61 receives the detection signal of the operation force sensor 23 via the input processor 51, and based on the detection signal, acquires an operation force fm. For example, the operation force acquirer 61 obtains, as the operation force fm, a force acting on the center of the handle 21 and expressed in the operation coordinate system from the detection signal of the operation force sensor 23. The operation force acquirer 61 inputs the operation force fm to the adder 63.

The contact force acquirer 62 receives the detection signal of the contact force sensor 13 via the input processor 41, and based on the detection signal, acquires a contact force fs. For example, the contact force acquirer 62 obtains, as the contact force fs, a force acting on the contact point of the end effector 11 with the object W and expressed in the tool coordinate system from the detection signal of the contact force sensor 13. The contact force acquirer 62 inputs the contact force fs to the adder 63.

The adder 63 calculates the sum of the operation force fm input from the operation force acquirer 61 and the contact force fs input from the contact force acquirer 62. Here, the operation force fm and the contact force fs are in opposite directions, and for this reason, the positive and negative signs are different between the operation force fm and the contact force fs. That is, by addition of the operation force fm and the contact force fs, the absolute value of the operation force fm becomes smaller.

The force-speed converter 64 generates a command speed xd′ from which the slave command and the master command are generated. The force-speed converter 64 has an operation converter 65 that generates an operation component which is a component according to the operation information on the operator 2 and a converter 66 that generates a conversion component which is a component equivalent to the coordinate conversion. The force-speed converter 64 generates the command speed xd′ by adding the conversion component to the operation component.

The operation converter 65 generates the operation component using the operation force fm detected by the operation force sensor 23 as the operation information. The operation converter 65 generates the operation component considering not only the operation information but also the reactive force information on the reactive force received from the object W by the robot 1. Specifically, the operation converter 65 generates, using the contact force fs detected by the contact force sensor 13 as the reactive force information, the operation component based on the operation information and the reactive force information. That is, the operation component is a command component according to at least the operation information, more specifically a command component according to the operation information and the reactive force information.

Specifically, the operation converter 65 converts a resultant force fm+fs which is the sum of the operation force fm and the contact force fs into a speed e′. The operation converter 65 calculates the speed e′ of an object when the resultant force fm+fs acts thereon using a motion model based on a motion equation including an inertial coefficient, a viscosity coefficient (damper coefficient), and a stiffness coefficient (spring coefficient). Specifically, the operation converter 65 calculates the speed e′ based on the following motion equation.

$$[ Equation 1 ]$$

$$md \cdot {e}^{″} + cd \cdot {e}^{′} + kd \cdot e = fm + fs \qquad ( 1 )$$

where e is an object position, md is an inertial coefficient, cd is a viscosity coefficient, kd is a stiffness coefficient, fm is an operation force, and fs is a contact force. Note that “′” indicates one-time differentiation and “″” indicates two-time differentiation.

Equation (1) is a linear differential equation, and when Equation (1) is solved for the speed e′, e′=V(fm, fs) is given. V(fm, fs) is a function having fm and fs as variables and md, cd, kd, etc. as constants.

The function V(fm, fs) is stored in the storage 32. The operation converter 65 reads the function V(fm, fs) from the storage 32, thereby obtaining the speed e′. The speed e′ is the operation component. Hereinafter, the speed e′ will be referred to as an “operation component e′.”

The converter 66 generates a conversion component s′. More specifically, the conversion component s′ is a command component for implementing the coordinate conversion to adapt the reference surface RP in the operation coordinate system to the surface of the object W while maintaining the posture of the end effector 11 with respect to the surface of the object W constant.

The converter 66 has an acquirer 67 that acquires the normal of the object to the intersection between the reference axis A defined in the tool coordinate system and the surface of the object W and a calculator 68 that obtains, as the conversion component s′, a command speed for moving the end effector 11 such that the reference axis is coincident with the normal.

The acquirer 67 obtains the position of the origin Ot and the direction of the Zt-axis in the tool coordinate system. In this example, the Zt-axis of the tool coordinate system is set as the reference axis A. The controller 3 receives, from the input processor 41, the detection signals of the rotation sensor and the current sensor of the servo motor 15 as the position information on the robot arm 12, and sequentially monitors the state (specifically, position and posture) of the robot arm 12. The acquirer 67 obtains the current position of the origin Ot and the current direction of the Zt-axis in the tool coordinate system from the current state of the robot arm 12. Moreover, the acquirer 67 reads the three-dimensional information 322 on the object W from the storage 32.

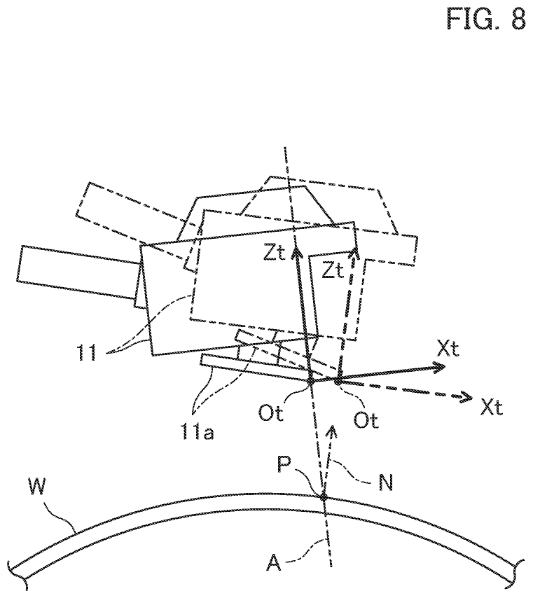

Then, as shown in FIG. 8, the acquirer 67 obtains the normal N to the intersection P between the reference axis A (Zt-axis) and the surface of the object W. FIG. 8 is a schematic view showing the normal N of the object W to the intersection P between the reference axis A and the object W.

Specifically, the acquirer 67 obtains a polygon through which the reference axis A penetrates from the polygons (i.e., minute triangular portions) of the surface of the object W. The acquirer 67 obtains the normal N to the polygon through which the reference axis A penetrates. For example, the acquirer 67 obtains the normal N which is a normal to a plane passing through three vertices of the polygon and passes through an intersection between the polygon and the reference axis A.

The calculator 68 obtains, as the conversion component s′, a command speed for moving the end effector 11 such that the reference axis A is coincident with the normal N obtained by the acquirer 67. In the example of FIG. 8, the conversion component s′ is a command speed for moving the end effector 11 indicated by a solid line to the position of the end effector 11 indicated by a chain double-dashed line.

The force-speed converter 64 adds the conversion component s′ to the operation component e′, thereby generating the command speed xd′. Addition of the conversion component s′ to the operation component e′ is equal to application of the coordinate conversion with the same adaptation relationship as adaptation of the reference surface RP to the surface of the object W to the operation component e′. The force-speed converter 64 outputs the generated command speed xd′ to the slave outputter 69 and the gain processor 610.

The slave outputter 69 generates the slave command based on the command speed xd′ (i.e., operation component e′ and conversion component s′). Specifically, the slave outputter 69 converts the command speed xd′ into the command position xds of the end effector 11. The command position xds is a position in the tool coordinate system. The command position xds is the slave command. For example, in a case where the ratio of the movement amount of the robot 1 to the movement amount of the operator 2 is set, the slave outputter 69 obtains the command position xds by multiplying the command position obtained from the command speed xd′ according to the movement ratio. The command speed xd′ is finally converted into the slave command. Thus, the operation component e′ can be regarded as the command component of the slave command expressed in the form of a speed, the command component corresponding to the operation information. The conversion component s′ can be regarded as the command component of the slave command expressed in the form of a speed, the command component being equivalent to the coordinate conversion.

The slave outputter 69 outputs the command position xds to the robot controller 14, specifically the movement controller 42. The movement controller 42 generates a control command for the servo motor 15 for implementing movement of the end effector 11 to the command position xds. The movement controller 42 outputs the generated control command to the servo motor 15, thereby moving the robot arm 12 and moving the end effector 11 to a position corresponding to the command position xds.

The gain processor 610 performs gain processing on the command speed xd′. The gain processor 610 adjusts the gain of each component of the command speed xd′. In this example, the gain processor 610 adjusts the gain of the conversion component s′ of the command speed xd′ to zero. That is, the gain processor 610 cancels the conversion component s′, and outputs only the operation component e′. The gain processor 60 outputs the processed command speed xd′ to the master outputter 611.

The master outputter 611 generates the master command based on the command speed xd′ subjected to the gain processing. Specifically, the master outputter 611 converts the command speed xd′ subjected to the gain processing into the command position xdm for the handle 21. The command position xdm is a position in the operation coordinate system. The command position xdm is the master command.

The master outputter 611 outputs the command position xdm to the operation controller 24, specifically the movement controller 52. The movement controller 52 generates a control command for the servo motors 25 for implementing movement of the handle 21 to the command position xdm. The movement controller 52 outputs the generated control command to the servo motors 25, thereby moving the support 22 and moving the handle 21 to a position corresponding to the command position xdm.

### [Movement of Robot System]

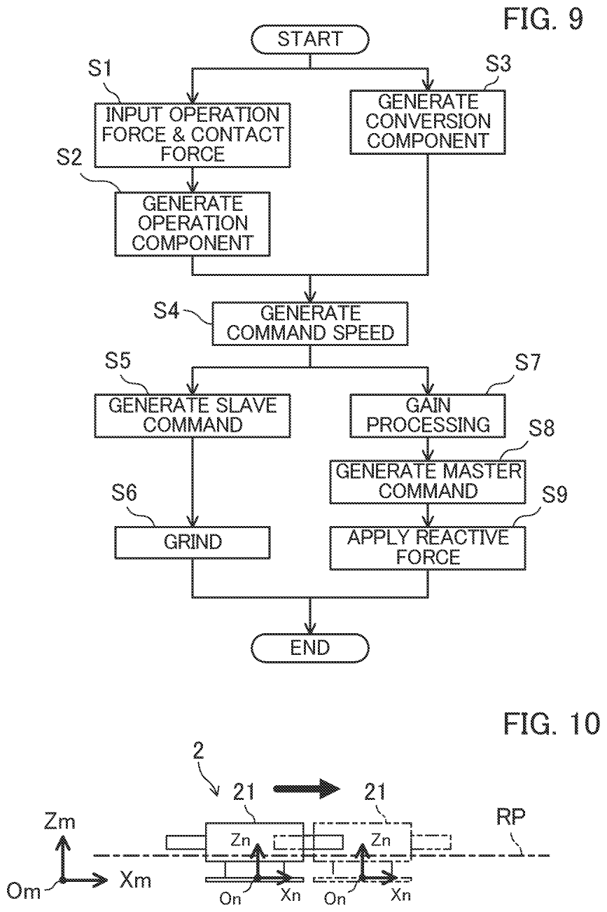

Next, movement of the robot system 100 configured in this manner will be described. FIG. 9 is a flowchart showing movement of the robot system 100. In this example, the user operates the operator 2 to grind the object W by the robot 1. The controller 3 repeatedly executes the processing of the flowchart shown in FIG. 9 in a predetermined control cycle.

First, in Step S1, the controller 3 acquires the operation force and the contact force. When the user operates the operator 2, the operation force applied from the user via the handle 21 is detected by the operation force sensor 23. The operation force detected by the operation force sensor 23 is input as a detection signal to the controller 3 by the input processor 51. At this time, the contact force detected by the contact force sensor 13 of the robot 1 is input as a detection signal to the contact force acquirer 62 of the controller 3 via the input processor 41.

In the controller 3, the operation force acquirer 61 inputs the operation force fm based on the detection signal to the adder 63. The contact force acquirer 62 inputs the contact force fs based on the detection signal to the adder 63.

Subsequently, in Step S2, the controller 3 generates the operation component e′ of the master command and the slave command. Specifically, the adder 63 inputs the resultant force fm+fs to the force-speed converter 64. The force-speed converter 64 obtains, using the function V(fm, fs), the operation component e′ from the resultant force fm+fs.

In parallel with Steps S1, S2, the controller 3 generates the conversion component s′ in Step S3. Specifically, the converter 66 derives the current position of the origin Ot and the current direction of the Zt-axis in the tool coordinate system. The converter 66 reads the three-dimensional information 322 on the object W from the storage 32, and obtains the intersection P between the Zt-axis, i.e., the reference axis A, and the surface of the object W. The converter 66 obtains the normal N of the surface of the object W to the obtained intersection P. Then, the converter 66 obtains, as the conversion component s′, the command speed for moving the end effector 11 such that the reference axis A is coincident with the normal N of the object W.

In Step S4, the controller 3 adds the conversion component s′ to the operation component e′, thereby generating the command speed xd′. Steps S1, S2, S3, S4 are equivalent to the coordinate conversion being performed to adapt the reference surface in the operation coordinate system set for the master to the surface of the object when the command for the mover is generated based on the operation information.

In Step S5, the controller 3 generates the slave command, i.e., the command position xds for the end effector 11, from the command speed xd′. Step S5 is equivalent to the command for the mover being output such that the effector moves according to the operation information input via the master.

In parallel, the controller 3 performs, in Step S7, the gain processing on the command speed xd′, thereby adjusting the angular speed component of the command speed xd′ to zero. Thereafter, in Step S8, the controller 3 generates the master command, i.e., the command position xdm for the handle 21, from the command speed xd′ subjected to the gain processing.

Thereafter, the controller 3 outputs the command position xds to the robot 1 in Step S6, and outputs the command position xdm to the operator 2 in Step S9. In this manner, the robot 1 moves according to the command position xds to execute grinding. In parallel, the operator 2 moves according to the command position xdm to apply the reactive force to the user.

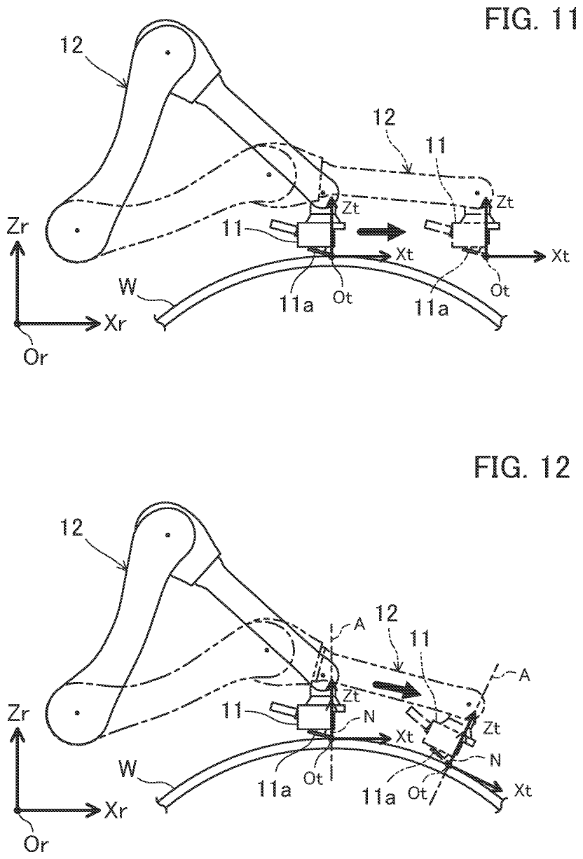

Movement of the end effector 11 etc. in the case of performing such processing will be described in detail. FIG. 10 is a schematic view of the handle 21 to be operated by the user. FIG. 11 is a schematic view showing movement of the end effector 11 in a case where the coordinate conversion is not performed. FIG. 12 is a schematic view showing movement of the end effector 11 in a case where the coordinate conversion is performed.

In this example, the user moves the handle 21 of the operator 2 along the reference surface RP, e.g., in the X-direction, as shown in FIG. 10. Accordingly, X-direction operation force including no Y-direction component and no Z-direction component is input from the operator 2 to the controller 3. At this time, the contact force acting on the robot 1 is also input to the controller 3.

The controller 3 obtains the operation component e′ according to the operation force from the operator 2, i.e., the resultant force fm+fs. Here, since the handle 21 is moved only in the X-direction, the resultant force fm+fs also has only an X-direction component. Thus, the operation component e′ includes only the X-direction component, and includes no Y-direction component, no Z-direction component, and no rotation component.

If the controller 3 simply generates the slave command from the operation component e′ without the coordinate conversion, the end effector 11 moves only in the X-direction of the tool coordinate system as shown in FIG. 11. That is, the end effector 11 executes, in the tool coordinate system, movement similar to or resembling movement of the handle 21 in the operation coordinate system. In this case, in order to move the end effector 11 along the surface of the object W, the user needs to input operation equivalent thereto to the handle 21. For example, the user needs to move the handle 21 in the Z-direction in addition to the X-direction. For this reason, the user needs to perform operation such as adjustment of the position of processing by the end effector 11 while performing operation for moving the end effector 11 along the surface of the object W.

On the other hand, the controller 3 performs the coordinate conversion to adapt the reference surface RP in the operation coordinate system to the surface of the object W when generating the slave command from the operation information. Specifically, as shown in FIG. 8, the controller 3 moves the end effector 11 such that the reference axis A is coincident with the normal N to the intersection P between the reference axis A and the surface of the object W (such movement is equivalent to the coordinate conversion). In this manner, the direction of the tool coordinate system is changed. The operation component e′ corresponds to the tool coordinate system. The operation component e′ includes only the X-direction component in this example. Since the direction of the Xt-axis of the tool coordinate system is changed, the end effector 11 moves in the direction of the changed Xt-axis. In the example of FIG. 12, the Zt-axis of the tool coordinate system is coincident with the normal N to the intersection P, and therefore, the Xt-axis of the tool coordinate system is in the direction of tangent of the object W to the intersection P. That is, the operation component e′ including only the X-direction component is converted into a component in the direction of tangent of the object W.

Such processing is repeated in the control cycle. That is, in each cycle, the reference axis A and the normal N of the object W corresponding to the reference axis A are obtained, and the posture of the end effector 11, i.e., the direction of the tool coordinate system, is sequentially changed. Specifically, the direction of the tool coordinate system is sequentially changed such that the XtYt plane of the tool coordinate system is parallel with the tangent plane of the object W to the intersection P.

As a result, when the user moves the handle 21 along the reference surface RP, the end effector 11 moves along the surface of the object W as shown in FIG. 12. It is not necessary for the user to intentionally operate the end effector 11 along the surface of the object W. The user can concentrate on operation other than operation for moving the end effector 11 along the surface of the object W, such as adjustment of the position of processing by the end effector 11 on the surface of the object W, the trajectory (i.e., the way to move the end effector 11) of movement of the end effector 11 upon processing (e.g., grinding), and the amount (e.g., depth of grinding) of processing by the end effector 11.

From another point of view, the user can move the end effector 11 along the surface of the object W by moving the handle 21 along the reference surface RP, and therefore, even in a case where the movement range of the handle 21 is limited, the end effector 11 can be relatively flexibly moved across a broad area. For example, the object W may have various surface shapes, and may have such a surface shape that the direction of normal to the surface of the object W changes substantially 180 degrees. In a configuration in which the handle 21 is supported by the support 22 as described above, the movement range of the handle 21 depends on the support 22. It is difficult to rotate the handle 21 substantially 180 degrees. Even in this case, the controller 3 converts movement of the handle 21 along the reference surface RP into movement of the end effector 11 along the surface of the object W. Even in operation within the limited range of movement of the handle 21 along the reference surface RP, the end effector 11 can be flexibly moved across a broad area according to various surface shapes of the object W. On this point, operability when the user moves the robot 1 by operation of the operator 2 can also be improved.

Further, in this example, in the coordinate conversion, the posture of the end effector 11 with respect to the surface of the object W is maintained constant. That is, as long as the posture (i.e., angle) of the handle 21 with respect to the reference surface RP is maintained constant, the end effector 11 moves along the surface of the object W while the posture of the end effector 11 with respect to the surface of the object W is maintained constant. The posture of the end effector 11 being maintained constant means that the angle of the reference axis A with respect to the normal N or tangent of the object W to the intersection P between the reference axis A defined in the tool coordinate system and the surface of the object W is maintained constant. Thus, operation of the handle 21 along the reference surface RP with the posture maintained constant with respect to the reference surface RP in the operation coordinate system is converted into movement of the end effector 11 along the surface of the object W with the posture maintained constant with respect to the surface of the object W.

In a case where the surface of the object W is curved, the end effector 11 needs to be rotated according to the position of the end effector 11 on the surface of the object W in order to maintain the posture of the end effector 11 with respect to the surface of the object W constant while moving the end effector 11 along the surface of the object W. According to the coordinate conversion by the controller 3, the user can move the end effector 11 along the surface of the object W with the posture maintained constant with respect to the surface of the object W by moving the handle 21 along the reference surface RP with the posture (e.g., angle) of the handle 21 maintained constant with respect to the reference surface RP without the need for other special operations. Particularly, even in a case where the surface of the object W has a complicated shape, the posture of the end effector 11 with respect to the surface of the object W can be maintained constant by easy operation.

As a result, in the case of griding, a tool such as a grinder can be moved along the surface of the object W by easy operation while the angle of the tool with respect to the surface of the object W is maintained constant. Thus, the surface of the object W can be uniformly, i.e., evenly, ground by easy operation. The action of the effector is not limited to grinding, and may be cutting or polishing, welding, coating, or assembly. A tool such as an end mill, a welding torch, or a coating gun can be moved along the surface of the object W by easy operation while the posture (e.g., angle) of the tool with respect to the surface of the object W is maintained constant. Alternatively, in a case where an opening of the object W extends in a predetermined direction with respect to the surface of the object W in assembly such as insertion of another component into the opening, the posture of the end effector 11 with respect to the surface of the object W is maintained constant so that the direction of the component with respect to the opening can be easily maintained constant. Thus, the component can be easily inserted into the opening. As a result, the surface of the object W can be uniformly, i.e., evenly, cut or polished, welded, coated, or assembled by easy operation.

Note that the coordinate conversion by the controller 3 does not mean that the end effector 11 can be moved only in the direction along the surface of the object W. For example, in a case where the handle 21 is moved in a direction intersecting with the reference surface RP, the end effector 11 is moved in a direction intersecting with the surface of the object W according to such operation information. Note that when the slave command is generated from the operation information, the coordinate conversion is executed with the same adaptation relationship as adaptation of the reference surface RP to the surface of the object W.

Since the posture of the end effector 11 with respect to the surface of the object W is maintained constant as long as the posture of the handle 21 with respect to the reference surface RP is constant, the adaptation relationship of the direction of operation of the handle 21 to the direction of movement of the end effector 11 with respect to the surface of the object W is maintained constant. That is, even if the position of the end effector 11 on the surface of the object W is changed, the direction of operation of the handle 21 in the operation coordinate system for moving the end effector 11 in a particular direction such as the direction of normal or tangent to the surface of the object W is not changed. For example, in the above-described example, even if the position of the end effector 11 on the surface of the object W is changed, operation of the handle 21 in the Zn-axis direction in the operation coordinate system is constantly converted into movement of the end effector 11 in the direction of normal to the surface of the object W. Thus, the user can operate the handle 21 without paying attention to the posture of the end effector 11 with respect to the surface of the object W much.

When the master command is generated from the command speed xd′, the conversion component s′ of the command speed xd′ is adjusted to zero, and the master command is generated using only the operation component e′ of the command speed xd′. Thus, movement of the handle 21 corresponding to movement of the end effector 11 following the surface of the object W is cancelled. If movement of the handle 21 is controlled corresponding to movement of the end effector 11 following the surface of the object W, the handle 21 may also rotate in association with rotation of the end effector 11 for maintaining the posture of the end effector 11 with respect to the surface of the object W constant. In this case, the reference surface RP is inclined with respect to the horizontal direction. That is, the master command is generated from the command speed xd′ without considering the conversion component s′ of the command speed xd′ so that rotation of the handle 21 can be reduced and the reference surface RP can be easily maintained horizontal. The user can easily move the handle 21 along the reference surface RP by horizontally moving the handle 21 without paying attention to rotational fluctuation of the reference surface RP.

As described above, the robot system 100 includes the operator 2 (master) to be operated by the user, the robot 1 (slave) having the end effector 11 (effector) that acts on the object W and the robot arm 12 (mover) that moves the end effector 11, and the controller 3 that outputs the command for the robot arm 12 such that the end effector 11 moves according to the operation information input via the operator 2. The controller 3 performs the coordinate conversion to adapt the reference surface RP in the operation coordinate system set for the operator 2 to the surface of the object W, and generates the command for the robot arm 12 based on the operation information.

In other words, the method for controlling the robot system 100 including the operator 2 (master) to be operated by the user and the robot 1 (slave) having the end effector 11 (effector) that acts on the object W and the robot arm 12 (mover) that moves the end effector 11 includes outputting the command for the robot arm 12 such that the end effector 11 moves according to the operation information input via the operator 2 and performing the coordinate conversion to adapt the reference surface RP in the operation coordinate system set for the operator 2 to the surface of the object W when generating the command for the robot arm 12 based on the operation information.

Further, in other words, the control program 321 causes the computer to implement the function of controlling the robot system 100 including the operator 2 (master) to be operated by the user and the robot 1 (slave) having the end effector 11 (effector) that acts on the object W and the robot arm 12 (mover) that moves the end effector 11, the function including the function of outputting the command for the robot arm 12 such that the end effector 11 moves according to the operation information input via the operator 2 and the function of performing the coordinate conversion to adapt the reference surface RP in the operation coordinate system set for the operator 2 to the surface of the object W when generating the command for the robot arm 12 based on the operation information.

According to these configurations, operation of the operator 2 along the reference surface RP is converted into movement of the end effector 11 along the surface of the object W. The user can move, without the need for operating the operator 2 considering the surface shape of the object W, the end effector 11 along the surface of the object W by moving the operator 2 along the reference surface RP. Even if the surface of the object W is curved or has a complicated shape, the user can move the end effector 11 along the surface of the object W by easy operation of the operator 2. As a result, the operability when the user moves the robot 1 by operation of the operator 2 can be improved. For example, since the user does not need to operate the operator 2 considering the surface shape of the object W, the user can focus on, e.g., adjustment of the position of the end effector 11 on the surface of the object W or adjustment of the strength of force on the handle 21, and accordingly, the accuracy of operation can be improved.

From another point of view, operation of the operator 2 along the reference surface RP is converted into movement of the end effector 11 along the surface of the object W, and therefore, even in a case where the movement range of the handle 21 is limited, the end effector 11 can be relatively flexibly moved across a broad area. Even in operation within the limited range of movement of the handle 21 along the reference surface RP, the end effector 11 can be flexibly moved across a broad area according to various surface shapes of the object W. On this point, the operability when the user moves the robot 1 by operation of the operator 2 can also be improved.

The reference surface RP is the plane in the operation coordinate system.

According to this configuration, the user can move the end effector 11 along the surface of the object W by two-dimensionally moving the operator 2 in the operation coordinate system. That is, the user can move the end effector 11 along the surface of the object W by performing operation via the operator 2 as if acting on a flat surface.

In the coordinate conversion, the controller 3 maintains the posture of the end effector 11 with respect to the surface of the object W constant.

According to this configuration, the controller 3 adjusts the posture of the end effector 11 such that the posture of the end effector 11 with respect to the surface of the object W is maintained constant when performing the coordinate conversion to adapt the reference surface RP in the operation coordinate system to the surface of the object W. Thus, the user does not need to perform a special operation of maintaining the posture of the end effector 11 with respect to the surface of the object W constant, and the posture of the end effector 11 with respect to the surface of the object W is automatically adjusted to be constant. As a result, the end effector 11 can uniformly, i.e., evenly, act on the object W.

Specifically, the controller 3 changes the posture of the end effector 11 such that the reference axis A defined in the tool coordinate system set for the end effector 11 is coincident with the normal N of the object W to the intersection P between the reference axis A and the surface of the object W, thereby maintaining the posture of the end effector 11 with respect to the surface of the object W constant.

According to this configuration, the posture of the end effector 11 with respect to the normal N to the surface of the object W is maintained constant.

The operator 2 has the handle 21 to be operated by the user and the support 22 (support) that supports the handle 21 and moves the handle 21, and the operation coordinate system is fixed to the handle 21.

According to this configuration, the handle 21 is supported by the support 22, and is moved by the support 22. That is, the handle 21 is movable. Since the operation coordinate system is fixed to the handle 21, the reference surface RP moves in association with movement of the handle 21. Since the relationship of the reference surface RP with the handle 21 is constant even when the handle 21 moves, the user can move the handle 21 while easily grasping the reference surface RP.

The operator 2 further has the operation force sensor 23 that detects the operation force applied to the handle 21 from the user, and the controller 3 has the operation converter 65 that obtains the operation component e′, which is the command component according to the operation information, using the operation force detected by the operation force sensor 23 as the operation information, the converter 66 that obtains the conversion component s′ which is the command component equivalent to the coordinate conversion, and the slave outputter 69 that generates the command for the robot arm 12 based on the operation component e′ and the conversion component s′.

According to this configuration, the operation force sensor 23 of the operator 2 detects, as the operation information, the operation force applied to the handle 21 from the user. The operation converter 65 of the controller 3 obtains the operation component e′ according to the operation force detected by the operation force sensor 23. Further, the converter 66 of the controller 3 obtains the conversion component s′ equivalent to the coordinate conversion. The slave outputter 69 of the controller 3 generates the command based on the operation component e′ and the conversion component s′. The operation converter 65 and the converter 66 separately obtain the operation component e′ and the conversion component s′ in this manner so that the processing of obtaining the operation component e′ and the conversion component s′ can be facilitated.

Specifically, the converter 66 has the acquirer 67 that acquires the normal N of the object W to the intersection P between the reference axis A defined in the tool coordinate system fixed to the end effector 11 and the surface of the object W, and the calculator 68 that obtains, as the conversion component s′, the command component for moving the end effector 11 such that the reference axis A is coincident with the normal N.

According to this configuration, the acquirer 67 first acquires the normal N of the object W to the intersection P between the reference axis A defined in the tool coordinate system for the end effector 11 and the surface of the object W. Thereafter, the calculator 68 obtains the conversion component s′ for moving the end effector 11 such that the reference axis A is coincident with the normal N. Since the command for the robot arm 12 is generated using the conversion component s′, the posture of the end effector 11 is adjusted such that the reference axis A is coincident with the normal N of the object W.

The robot system 100 further includes the contact force sensor 13 (contact force detector) that detects the contact force which is the reactive force acting on the end effector 11 from the object W. The operation converter 65 obtains the operation component e′ based on the operation force detected by the operation force sensor 23 and the contact force detected by the contact force sensor 13, and the controller 3 further has the master outputter 611 that generates the command for the support 22 for moving the handle 21 based on the operation component e′.

According to this configuration, the operation converter 65 obtains the operation component e′ based not only on the operation force detected by the operation force sensor 23 but also on the contact force detected by the contact force sensor 13. As a result, the end effector 11 moves according not only to the operation force but also to the contact force. Further, the operation component e′ is used not only for generating the command for the robot arm 12, but also for generating the command for the support 22 of the operator 2. As a result, the operator 2 can apply the reactive force according to the contact force to the user. That is, the user can operate the operator 2 while feeling the reactive force acting on the end effector 11.

Specifically, the master outputter 611 generates the command for the support 22 based on the operation component e′ without considering the conversion component s′.

According to this configuration, the command for the robot arm 12 is generated based on the operation component e′ and the conversion component s′. On the other hand, the command for the support 22 is generated based on the operation component e′, and does not reflect the conversion component s′. That is, the end effector 11 moves according to the operation information and the coordinate conversion, and on the other hand, the support 22 does not reflect the coordinate conversion and moves according to the operation information. Specifically, even when the end effector 11 moves along the surface of the object W, the handle 21 does not move in accordance with the surface shape of the object W. Thus, the user can easily move the handle 21 along the reference surface RP.

The action of the end effector 11 on the object W is grinding, cutting, or polishing.

In grinding, cutting, or polishing, the end effector 11 contacts the object W, and the reactive force from the object W acts on the end effector 11. The user operates the operator 2 while receiving the reactive force based on the contact force detected by the contact force sensor 13. The user operates the handle 21 to move the end effector 11 along the surface of the object W while feeling the reactive force. At this time, the user can move, only by operating the handle 21 in the direction along the reference surface RP, the end effector 11 along the surface of the object W while feeling the reactive force from the object W. As a result, the operability of the robot 1 in execution of grinding, cutting, or polishing on the object W can be improved.

### <Modification>

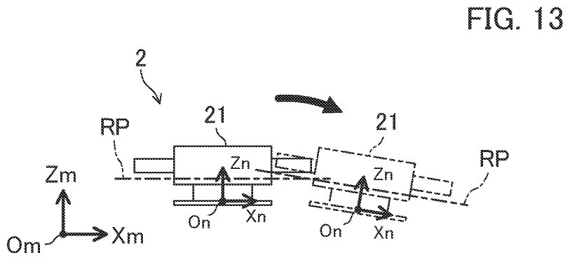

Next, a modification of the robot system 100 will be described. FIG. 13 is a schematic view of the handle 21 to be operated by the user in the modification. This modification is different from the above-described example in the way to obtain the master command from the command speed xd′.

Specifically, the gain processor 610 of the controller 3 outputs the command speed xd′ to the master outputter 611 without adjusting the gain of the conversion component s′ of the command speed xd′ to zero, i.e., without canceling the conversion component s′. Thus, the master outputter 611 generates the master command, i.e., the command position xdm, based on the operation component e′ and the conversion component s′.

Thus, movement of the end effector 11 is not different from that of the above-described example. That is, when the handle 21 is moved along the reference surface RP, the end effector 11 moves along the surface of the object W with the posture maintained constant with respect to the surface of the object W, as shown in FIG. 12.

At this time, the handle 21 performs movement reflecting both movement of the end effector 11 due to the operation component e′ and movement of the end effector 11 due to the conversion component s′. That is, as shown in FIG. 13, the handle 21 is moved by the support 22 so as to draw a trajectory along the surface of the object W with the posture maintained substantially constant with respect to the surface of the object W. The user applies the operation force to the handle 21 in the direction along the reference surface RP, and does not intentionally operate the handle 21 such that the handle 21 draws the trajectory along the surface of the object W. That is, the user can operate the handle 21 without intentionally operating the handle 21 along the surface of the object W while sensing the surface shape of the object W.

Note that the reference surface RP is defined in the operation coordinate system fixed to the handle 21, and therefore, moves similarly to movement of the handle 21. When the posture of the handle 21 changes, the posture, i.e., angle, of the reference surface RP changes accordingly. The user grips the handle 21 so that the user can sense the posture of the handle 21 and can substantially grasp the angle of the reference surface RP. Thus, even if the posture of the handle 21 changes, the user can easily move the handle 21 along the reference surface RP.

As described above, in the modification, the master outputter 611 generates the command for the support 22 based not only on the operation component e′ but also on the conversion component s′.

According to this configuration, even in operation of the handle 21 along the reference surface RP, the handle 21 can be moved similarly to movement of the end effector 11 along the surface of the object W. As a result, the user can operate the handle 21 without intentionally operating the handle 21 along the surface of the object W while sensing the surface shape of the object W.

### Other Embodiments

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the master is not limited to the operator 2, and an arbitrary configuration can be employed as long as the operation information can be input by the user. The slave is not limited to the robot 1, and an arbitrary configuration can be employed as long as the effector that acts on the object and the mover that moves the effector are included therein.

The three-dimensional information 322 on the object W is not limited to the STL data. The three-dimensional information 322 on the object is only required to be data from which a normal to an arbitrary portion of the surface of the object can be acquired and may be, for example, point cloud data. Alternatively, the three-dimensional information 322 on the object may be information itself on a normal to each portion of the surface of the object.

The above-described coordinate conversion method is merely one example, and is not limited to above. The coordinate conversion is only required to be performed to adapt the reference surface in the master coordinate system to the surface of the object, and it is not essential to maintain the posture of the effector with respect to the surface of the object constant. That is, in the above-described example of FIGS. 11 and 12, in the coordinate conversion, only the position of the end effector 11 in the direction of the Zr-axis may be adjusted, without rotating the end effector 11, such that a distance between the end effector 11 and the surface of the object W in the direction of the Zr-axis of the master coordinate system is constant.

The above-described method for calculating the command position xds and the command position xdm from the resultant force fm+fs is merely one example. For example, the motion model is merely one example, and a different motion model may be used.

The gain processor 610 may adjust not the gain of the conversion component s′ to zero, but the gain of a rotation component of the command speed xd′ for each of the three axes to zero. That is, the gain processor 610 may cancel the angular speed component of the command speed xd′ and output only a translation component of the command speed xd′ for each of the three axes. The rotation component of the command speed xd′ is cancelled, and accordingly, rotation of the handle 21 is reduced. By this method, the user can also easily horizontally move the handle 21.

The above-described block diagrams are examples, and blocks may be implemented as one block, one block may be divided into blocks, or some functions may be transferred to another block.

The above-described flowchart is one example, and the step(s) may be omitted or changed. Alternatively, the order of steps may be changed, steps performed in series may be processed in parallel, or steps performed in parallel may be processed in series.

The technique of the present disclosure may be a non-transitory computer-readable recording medium recording the above-described program. The above-described program may be distributed via a transfer medium such as the Internet.

The functions of the configuration disclosed in the present embodiment may be implemented using an electric circuit or a processing circuit. The processor is, for example, a processing circuit including a transistor and other circuits. In the present disclosure, a unit, a controller, or means is hardware or a program for implementing the described functions. Here, the hardware is hardware disclosed in the present embodiment or well-known hardware which is configured or programmed to implement the functions disclosed in the present embodiment. In a case where the hardware is a processor or a controller, a circuit, means, or a unit is a combination of hardware and software, and the software is used for configuring the hardware and/or the processor.

1. A robot system comprising:
a master to be operated by a user;
a slave having an effector that acts on an object and a mover that moves the effector; and
a controller that outputs a command for the mover such that the effector moves according to operation information input via the master,
wherein the controller performs coordinate conversion to adapt a reference surface in an operation coordinate system set for the master to a surface of the object, and generates the command for the mover based on the operation information.

2. The robot system of claim 1, wherein
the reference surface is a plane in the operation coordinate system.

3. The robot system of claim 1, wherein
in the coordinate conversion, the controller maintains a posture of the effector with respect to the surface of the object constant.

4. The robot system of claim 3, wherein
the controller changes the posture of the effector such that a reference axis defined in a tool coordinate system set for the effector is coincident with a normal of the object to an intersection between the reference axis and the surface of the object, thereby maintaining the posture of the effector with respect to the surface of the object constant.

5. The robot system of claim 1, wherein
the master has a handle to be operated by the user and a support that supports the handle and moves the handle, and
the operation coordinate system is fixed to the handle.

6. The robot system of claim 5, wherein
the master further has an operation force detector that detects operation force applied to the handle from the user, and
the controller has
an operation converter that obtains an operation component, which is a command component according to the operation information, using the operation force detected by the operation force detector as the operation information,
a converter that obtains a conversion component which is a command component equivalent to the coordinate conversion, and
a slave outputter that generates the command for the mover based on the operation component and the conversion component.

7. The robot system of claim 6, wherein
the converter has
an acquirer that acquires a normal of the object to an intersection between a reference axis defined in a tool coordinate system fixed to the effector and the surface of the object, and
a calculator that obtains, as the conversion component, a command component for moving the effector such that the reference axis is coincident with the normal.

8. The robot system of claim 6, further comprising:
a contact force detector that detects contact force which is reactive force acting on the effector from the object,
wherein the operation converter obtains the operation component based on the operation force detected by the operation force detector and the contact force detected by the contact force detector, and
the controller further has a master outputter that generates a command for the support for moving the handle based on the operation component.

9. The robot system of claim 8, wherein
the master outputter generates the command for the support based on the operation component without considering the conversion component.

10. The robot system of claim 8, wherein
the master outputter generates the command for the support based not only on the operation component but also on the conversion component.

11. The robot system of claim 8, wherein
an action of the effector on the object is grinding, cutting, or polishing.

12. A method for controlling a robot system including a master to be operated by a user and a slave having an effector that acts on an object and a mover that moves the effector, comprising:
outputting a command for the mover such that the effector moves according to operation information input via the master; and
performing coordinate conversion to adapt a reference surface in an operation coordinate system set for the master to a surface of the object when generating the command for the mover based on the operation information.

13. An article of manufacture comprising a computer-readable medium storing a control program, when executed, causing a computer to implement a function of controlling a robot system including a master to be operated by a user and a slave having an effector that acts on an object and a mover that moves the effector, the function including
a function of outputting a command for the mover such that the effector moves according to operation information input via the master, and
a function of performing coordinate conversion to adapt a reference surface in an operation coordinate system set for the master to a surface of the object when generating the command for the mover based on the operation information.
